(19) United States
(12) Patent Application Publication
(10) Pub. No.: US 2012/0016071 A1
(43) Pub. Date: Jan. 19, 2012

(54) POLYFUNCTIONAL (METH)ACRYLIC POLYMER, COATING COMPOSITION, PROCESS FOR PRODUCING A COATING AND COATED ARTICLE

(75) Inventors: Bardo Schmitt, Mainz-Kastel (DE); Wolfgang Klesse, Mainz (DE); Martina Ebert, Dieburg (DE); Thorben Schuetz, Seeheim-Jugenheim (DE); Mario Gomez Andreu, Pfungstadt (DE)

(73) Assignee: Evonik Roehm GmbH, Darmstadt (DE)

(21) Appl. No.: 13/259,184

(22) PCT Filed: Mar. 3, 2010
(86) PCT No.: PCT/EP2010/052672

§ 371 Date: Sep. 23, 2011

(30) Foreign Application Priority Data
Mar. 30, 2009 (DE) 10 2009 001 964.2

(51) Int. Cl. C09D 135/06; B05D 3/00; B05D 7/14; C08F 222/38; B05D 7/24

(52) U.S. Cl. 524/553; 526/282; 427/385.5; 427/388.1

(57) ABSTRACT

The present invention relates to a (meth)acrylate polymer for preparing a coating composition, where the (meth)acrylate polymer comprises
0.5% to 20% by weight of units derived from (meth)acrylic monomers which in the alkyl radical have at least one double bond and 8 to 40 carbon atoms,
0.1% to 60% by weight of units derived from hydroxyl-containing monomers which have up to 9 carbon atoms,
0.1% to 95% by weight of units derived from (meth)acrylates having 1 to 12 carbon atoms in the alkyl radical, and
0.1% to 60% by weight of units derived from styrene monomers, based in each case on the weight of the (meth)acrylate polymer,
and the (meth)acrylate polymer has a weight-average molecular weight in the range from 2000 to 60 000 g/mol.

The present invention further relates to a coating composition and to a method of producing a coating. The present invention describes, furthermore, a coated article comprising a coating obtainable by the method.

The present invention relates to a multi-functional (meth)acrylic polymer and to a coating composition. Furthermore, the present invention is directed to a method of producing a coating which is carried out using this coating composition, and to a coated article obtainable by the present method.

Coating materials, paints in particular, have been synthetically produced for a long time. One important group of these materials is based on aqueous dispersions which in many cases comprise (meth)acrylate polymers. For example, the publication DE-A-41 05 134 describes aqueous dispersions comprising alkyl methacrylates as binders. Paints of this kind are also known from U.S. Pat. No. 5,750,751, EP-A-1 044 993 and WO 2006/013061. Moreover, from publication DE-A-27 32 693 in particular, solvent-based coating materials are known which can be crosslinked by polyisocyanates.

Furthermore, the publication DE 30 27 308 describes coating compositions based on (meth)acrylates which can be crosslinked oxidatively. These polymers, furthermore, have units derived from hydroxyalkyl (meth)acrylates.

As well as aqueous dispersions, reactive paints form a further group of known coating materials. Paints of this kind are known from EP-0 693 507, for example.

The spectrum of properties of the coating compositions identified above is already good. Nevertheless, there is an ongoing need to improve this spectrum of properties. For instance, coatings obtainable from some of the coating compositions described above exhibit a hardness that is insufficient for heightened requirements. If the hardness is increased by raising of the degree of crosslinking, however, an increasing brittleness occurs. Moreover, the resistance to chemicals, especially towards polar solvents, is in need of improvement.

In view of the prior art, then, it is an object of the present invention to provide polymers and coating compositions having outstanding properties. These properties include in particular a high chemical resistance on the part of the coatings obtainable from the coating materials. The aim here is to obtain a high stability towards a large number of different solvents and also towards bases and acids. In particular there should be very good resistance towards methyl ethyl ketone (MEK).

It ought, furthermore, to be possible to vary the hardness of the coatings obtainable from the coating materials over a wide range. In particular, particularly hard and scratch-resistant coatings ought to be able to be obtained from the polymers and coating compositions. Moreover, coatings obtainable from the polymers or coating materials of the invention ought to have a relatively low brittleness, relative to the hardness.

It was also an object of the present invention, therefore, to provide a coating composition which has a particularly long storage life and durability. A further object is seen as being that of providing coating materials which lead to coatings having a high gloss. The coatings obtainable from the coating materials ought to exhibit high weathering stability, particularly a high UV resistance.

Furthermore, the coating materials ought to exhibit good processing properties over a large temperature and humidity range. In relation to their performance capacity, the coating materials ought to display improved environmental compatibility. In particular, minimal amounts of organic solvents ought to be released into the environment through evaporation.

A further object can be seen as that of specifying coating materials which can be obtained very inexpensively and on an industrial scale.

These and other objects which, although not set out explicitly, are nevertheless readily derivable or inferable from the contexts discussed in the foregoing introduction are achieved by means of a (meth)acrylate polymer for preparing a coating composition having all of the features of Claim 1. Advantageous modifications of the (meth)acrylate polymer of the invention are protected in dependent claims. With regard to a coating composition, to a method of producing a coating and to a coated article, Claims 11, 16 and 18 offer an achievement of the underlying objects.

The present invention accordingly provides a multi-functional (meth)acrylate polymer for preparing a coating composition, characterized in that the (meth)acrylate polymer comprises

0.5% to 20% by weight of units derived from (meth)acrylic monomers which in the alkyl radical have at least one double bond and 8 to 40 carbon atoms,

0.1% to 60% by weight of units derived from hydroxyl-containing monomers which have up to 9 carbon atoms,

0.1% to 95% by weight of units derived from (meth)acrylates having 1 to 12 carbon atoms in the alkyl radical, and

0.1% to 60% by weight of units derived from styrene monomers, based in each case on the weight of the (meth)acrylate polymer,

and the (meth)acrylate polymer has a weight-average molecular weight in the range from 2000 to 60 000 g/mol.

Through the measures according to the invention it is additionally possible to obtain advantages including the following:

The coatings obtainable from the polymers and the coating compositions of the present invention display a high chemical resistance. In this context it is possible to achieve a high stability towards many different solvents and also towards bases and acids. In many cases, in particular, a very good resistance towards methyl ethyl ketone (MEK) is obtained. A very good resistance towards water can be achieved as well. Consequently these coating compositions can be used for producing protective coatings.

Furthermore, the hardness of the coatings obtainable from the polymers and the coating compositions can be varied over a wide range. In particular it is possible to obtain particularly hard, scratch-resistant coatings.

Moreover, coatings obtainable from the polymers and coating compositions of the invention have a relatively low brittleness, relative to the hardness and the chemical resistance.

In addition to this, the polymers and coating compositions of the invention have good processing properties over a large temperature and humidity range. In relation to the performance capacity, the coating compositions exhibit improved environmental compatibility. Thus extremely small amounts of organic solvents are released into the environment as a result of evaporation. In this case the coating compositions can comprise a high solids content.

Furthermore, coating compositions of the invention lead to coatings having a high gloss. The coating compositions of the present invention exhibit a particularly long storage life and durability.

The coatings obtainable from the coating compositions exhibit high weathering stability, more particularly a high UV resistance.

In addition, the coating compositions of the invention are obtainable on an industrial scale and in a particularly cost-effective way.

The (meth)acrylate polymer of the invention comprises 0.5% to 20%, preferably 1% to 15% and very preferably 2% to 12% by weight of units derived from (meth)acrylic monomers which in the alkyl radical have at least one double bond and 8 to 40 carbon atoms, based on the weight of the (meth)acrylate polymer.

The (meth)acrylate polymers may be obtained preferably by free-radical polymerization. Accordingly, the weight fraction of the respective units possessed by these polymers is a product of the weight fractions of corresponding monomers that are used for preparing the polymers, since the weight fraction of groups derived from initiators or from molecular weight regulators can typically be disregarded.

The term “multi-functional (meth)acrylate polymer” means that the polymer can be cured not only by atmospheric oxygen but also by crosslinking agents which are able to react with the hydroxyl groups of the (meth)acrylate polymer.

(Meth)acrylic monomers which in the alkyl radical have at least one double bond and 8 to 40 carbon atoms are esters or amides of (meth)acrylic acid whose alkyl radical has at least one carbon-carbon double bond and 8 to 40 carbon atoms. The (meth)acrylic acid notation denotes methacrylic acid and acrylic acid and also mixtures thereof. The alkyl or alcohol or amide radical may have preferably 10 to 30 and more preferably 12 to 20 carbon atoms, and this radical may comprise heteroatoms, especially oxygen, nitrogen or sulphur atoms. The alkyl radical may have one, two, three or more carbon-carbon double bonds. The polymerization conditions under which the (meth)acrylate polymer is prepared are preferably chosen so as to maximize the proportion of alkyl radical double bonds retained in the polymerization. This can be accomplished, for example, by sterically hindering the double bonds present in the alcohol radical. Moreover, at least some and preferably all of the double bonds present in the alkyl radical of the (meth)acrylic monomer have a lower reactivity in a free-radical polymerization than a (meth)acryloyl group, and so there are preferably no further (meth)acryloyl groups present in the alkyl radical.

The iodine number of the (meth)acrylic monomers to be used for preparing the (meth)acrylic polymers and having in the alkyl radical at least one double bond and 8 to 40 carbon atoms is preferably at least 50, more preferably at least 100 and very preferably at least 125 g iodine/100 g (meth)acrylic monomer.

(Meth)acrylic monomers of this kind correspond in general to the formula (I)

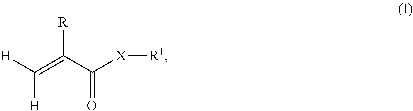

in which the radical R is hydrogen or methyl, X independently is oxygen or a group of the formula NR′, in which R′ is hydrogen or a radical having 1 to 6 carbon atoms, and R¹ is a linear or branched radical having 8 to 40, preferably 10 to 30 and more preferably 12 to 20 carbon atoms and having at least one C—C double bond.

(Meth)acrylic monomers which in the alkyl radical have at least one double bond and 8 to 40 carbon atoms may be obtained, for example, by esterification of (meth)acrylic acid, reaction of (meth)acryloyl halides or transesterification of (meth)acrylates with alcohols which have at least one double bond and 8 to 40 carbon atoms.

Correspondingly, (meth)acrylamides can be obtained by reaction with an amine. These reactions are set out in, for example, Ullmann's Encyclopedia of Industrial Chemistry, 5th edition on CD-ROM, or F.-B. Chen, G. Bufkin, “Crosslinkable Emulsion Polymers by Autooxidation I”, Journal of Applied Polymer Science, Vol. 30, 4571-4582 (1985).

The alcohols suitable for such reaction include, among others, octenol, nonenol, decenol, undecenol, dodecenol, tridecenol, tetradecenol, pentadecenol, hexadecenol, heptadecenol, octadecenol, nonadecenol, icosenol, docosenol, octadienol, nonadienol, decadienol, undecadienol, dodecadienol, tridecadienol, tetradecadienol, pentadecadienol, hexadecadienol, heptadecadienol, octadecadienol, nonadecadienol, icosadienol and/or docosadienol. These so-called fatty alcohols are in some cases available commercially or can be obtained from fatty acids, this reaction being set out in, for example, F.-B. Chen, G. Bufkin, Journal of Applied Polymer Science, Vol. 30, 4571-4582 (1985).

The preferred (meth)acrylates obtainable by this process include, in particular, octadienyl(meth)acrylate, octadecadienyl(meth)acrylate, octadecatrienyl(meth)acrylate, hexadecenyl(meth)acrylate, octadecenyl(meth)acrylate and hexadecadienyl(meth)acrylate.

Furthermore, (meth)acrylates which in the alkyl radical have at least one double bond and 8 to 40 carbon atoms can also be obtained by reaction of unsaturated fatty acids with (meth)acrylates which have reactive groups in the alkyl radical, more particularly alcohol radical. The reactive groups include, in particular, hydroxyl groups and also epoxy groups. Use may accordingly be made, for example, among others, of hydroxyalkyl(meth)acrylates, such as 3-hydroxypropyl(meth)acrylate, 3,4-dihydroxybutyl(meth)acrylate, 2-hydroxyethyl(meth)acrylate, 2-hydroxypropyl(meth)acrylate, 2,5-dimethyl-1,6-hexanediol(meth)acrylate, 1,10-decanediol(meth)acrylate; or (meth)acrylates containing epoxy groups, such as glycidyl(meth)acrylate, for example, as reactants for preparing the aforementioned (meth)acrylates.

Suitable fatty acids for reaction with the aforementioned (meth)acrylates are in many cases available commercially and are obtained from natural sources. They include, among others, undecylenic acid, palmitoleic acid, oleic acid, elaidic acid, vaccenic acid, icosenoic acid, cetoleic acid, erucic acid, nervonic acid, linoleic acid, linolenic acid, arachidonic acid, timnodonic acid, clupanodonic acid and/or cervonic acid.

The preferred (meth)acrylates obtainable by this process include, in particular, (meth)acryloyloxy-2-hydroxypropyl-linoleic acid ester, (meth)acryloyloxy-2-hydroxypropyl-linolenic acid ester and (meth)acryloyloxy-2-hydroxypropyl-oleic acid ester.

The reaction of the unsaturated fatty acids with (meth)acrylates which have reactive groups in the alkyl radical, more particularly alcohol radical, is known per se and is set out in, for example, DE-A-41 05 134, DE-A-25 13 516, DE-A-26 38 544 and U.S. Pat. No. 5,750,751.

In one preferred embodiment it is possible to use (meth)acrylic monomers of the general formula (II)

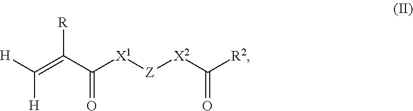

in which R is hydrogen or a methyl group, X¹ and X² independently are oxygen or a group of the formula NR′, in which R′ is hydrogen or a radical having 1 to 6 carbon atoms, with the proviso that at least one of the groups X¹ and X² is a group of the formula NR′, in which R′ is hydrogen or a radical having 1 to 6 carbon atoms, Z is a linking group, and R² is an unsaturated radical having 9 to 25 carbon atoms.

Surprising advantages can be obtained, moreover, through the use of a (meth)acrylic monomer of the general formula (III)

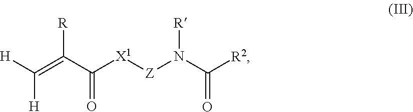

in which R is hydrogen or a methyl group, X¹ is oxygen or a group of the formula NR′, in which R′ is hydrogen or a radical having 1 to 6 carbon atoms, Z is a linking group, R′ is hydrogen or a radical having 1 to 6 carbon atoms and R² is an unsaturated radical having 9 to 25 carbon atoms.

The expression “radical having 1 to 6 carbon atoms” stands for a group which has 1 to 6 carbon atoms. It encompasses aromatic and heteroaromatic groups and also alkyl, cycloalkyl, alkoxy, cycloalkoxy, alkenyl, alkanoyl, alkoxycarbonyl groups and also heteroaliphatic groups. These groups may be branched or unbranched. Moreover, these groups may have substituents, especially halogen atoms or hydroxyl groups.

The radicals R′ stand preferably for alkyl groups. The preferred alkyl groups include the methyl, ethyl, propyl, isopropyl, 1-butyl, 2-butyl, 2-methylpropyl or tert-butyl group.

The group Z stands preferably for a linking group which comprises 1 to 10, preferably 1 to 5 and very preferably 2 to 3 carbon atoms. Such radicals include, in particular, linear or branched, aliphatic or cycloaliphatic radicals, such as, for example, a methylene, ethylene, propylene, isopropylene, n-butylene, isobutylene, tert-butylene or cyclohexylene group, the ethylene group being particularly preferred.

The group R² in formula (II) stands for an unsaturated radical having 9 to 25 carbon atoms. These groups encompass, in particular, alkenyl, cycloalkenyl, alkenoxy, cycloalkenoxy, alkenoyl and also heteroaliphatic groups. Furthermore, these groups may have substituents, especially halogen atoms or hydroxyl groups. The preferred groups include, in particular, alkenyl groups, such as, for example, the nonenyl, decenyl, undecenyl, dodecenyl, tridecenyl, tetradecenyl, pentadecenyl, hexadecenyl, heptadecenyl, octadecenyl, nonadecenyl, eicosenyl, heneicosenyl, docosenyl, octadienyl, nonadienyl, decadienyl, undecadienyl, dodecadienyl, tridecadienyl, tetradecadienyl, pentadecadienyl, hexadecadienyl, heptadecadienyl, octadecadienyl, nonadecadienyl, eicosadienyl, heneicosadienyl, docosadienyl, tricosadienyl and/or heptadecatrienyl group.

The preferred (meth)acrylic monomers of formula (II) and (III), respectively, include, among others, heptadecenyloyloxy-2-ethyl-(meth)acrylamide, heptadecadienyloyloxy-2-ethyl-(meth)acrylamide, heptadecatrienyloyloxy-2-ethyl-(meth)acrylamide, heptadecenyloyloxy-2-ethyl-(meth)acrylamide, (meth)acryloyloxy-2-ethyl-palmitoleamide, (meth)acryloyloxy-2-ethyl-oleamide, (meth)acryloyloxy-2-ethyl-icosenamide, (meth)acryloyloxy-2-ethyl-cetoleamide, (meth)acryloyloxy-2-ethyl-erucamide, (meth)acryloyloxy-2-ethyl-linoleamide, (meth)acryloyloxy-2-ethyl-linolenamide, (meth)acryloyloxy-2-propyl-palmitoleamide, (meth)acryloyloxy-2-propyl-oleamide, (meth)acryloyloxy-2-propyl-icosenamide, (meth)acryloyloxy-2-propyl-cetoleamide, (meth)acryloyloxy-2-propyl-erucamide, (meth)acryloyloxy-2-propyl-linoleamide and (meth)acryloyloxy-2-propyl-linolenamide.

The (meth)acryloyl notation stands for acryloyl and methacryloyl radicals, with methacryloyl radicals being preferred. Particularly preferred monomers of formula (II) and (III) are methacryloyloxy-2-ethyl-oleamide, methacryloyloxy-2-ethyl-linoleamide, and/or methacryloyloxy-2-ethyl-linolenamide.

The (meth)acrylic monomers of formula (II) and (III) can be obtained in particular by multi-stage processes. In a first stage, for example, one or more unsaturated fatty acids or fatty acid esters can be reacted with an amine, such as ethylenediamine, ethanolamine, propylenediamine or propanolamine, for example, to form an amide. In a second stage, the hydroxyl group or the amine group of the amide is reacted with a (meth)acrylate, methyl (meth)acrylate for example, to give the monomers of the formula (II) or (III). For preparing monomers in which X¹ is a group of the formula NR′, in which R′ is hydrogen or a radical having 1 to 6 carbon atoms, and X² is oxygen, correspondingly, it is possible first to react an alkyl (meth)acrylate, methyl (meth)acrylate for example, with one of the aforementioned amines, to form a (meth)acrylamide having a hydroxyl group in the alkyl radical, which is subsequently reacted with an unsaturated fatty acid to form a (meth)acrylic monomer of formula (II) or (III). Transesterifications of alcohols with (meth)acrylates, or the preparation of (meth)acrylamides, are set out in publications including CN 1355161, DE 21 29 425, DE 34 23 443 or EP-A-0 534 666, the reaction conditions described in these publications and also the catalysts, etc., set out therein being incorporated for purposes of disclosure into this specification. Moreover, these reactions are described in “Synthesis of Acrylic Esters by Transesterification”, J. Haken, 1967.

Intermediates obtained in these reactions, such as carboxamides which have hydroxyl groups in the alkyl radical, for example, can be purified. In one particular embodiment of the present invention, resultant intermediates can be reacted without costly and inconvenient purification, to form the (meth)acrylic monomers of formula (II) or (III).

Furthermore, the (meth)acrylic monomers having 8 to 40, preferably 10 to 30 and more preferably 12 to 20 carbon atoms and at least one double bond in the alkyl radical include, in particular, monomers of the general formula (IV)

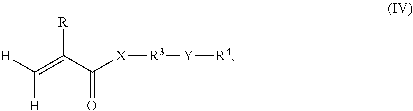

in which R is hydrogen or a methyl group, X is oxygen or a group of the formula NR′, in which R′ is hydrogen or a radical having 1 to 6 carbon atoms, R³ is an alkylene group having 1 to 22 carbon atoms, Y is oxygen, sulphur or a group of the formula NR″, in which R″ is hydrogen or a radical having 1 to 6 carbon atoms, and R⁴ is an unsaturated radical having at least 8 carbon atoms and at least two double bonds.

In formula (IV) the radical R³ is an alkylene group having 1 to 22 carbon atoms, preferably having 1 to 10, more preferably having 2 to 6, carbon atoms. In one particular embodiment of the present invention the radical R³ is an alkylene group having 2 to 4, more preferably 2, carbon atoms. The alkylene groups having 1 to 22 carbon atoms include, in particular, the methylene, ethylene, propylene, isopropylene, n-butylene, iso-butylene, tert-butylene or cyclohexylene group, the ethylene group being particularly preferred.

The radical R⁴ comprises at least two C—C double bonds which are not part of an aromatic system. The radical R⁴ is preferably a group having precisely 8 carbon atoms which has precisely two double bonds. The radical R⁴ is preferably a linear hydrocarbon radical which contains no heteroatoms. In one particular embodiment of the present invention the radical R⁴ in formula (IV) may comprise a terminal double bond. In another modification of the present invention the radical R⁴ in formula (IV) may comprise no terminal double bond. The double bonds present in the radical R⁴ may preferably be conjugated. In a further preferred embodiment of the present invention the double bonds present in the radical R⁴ are not conjugated. The preferred radicals R⁴ which have at least two double bonds include, among others, the octa-2,7-dienyl group, octa-3,7-dienyl group, octa-4,7-dienyl group, octa-5,7-dienyl group, octa-2,4-dienyl group, octa-2,5-dienyl group, octa-2,6-dienyl group, octa-3,5-dienyl group, octa-3,6-dienyl group and octa-4,6-dienyl group.

The (meth)acrylic monomers of the general formula (IV) include, among others, 2-[((2-E)octa-2,7-dienyl)methylamino]ethyl 2-methylprop-2-enoate, 2-[((2-Z)octa-2,7-dienyl)methylamino]ethyl 2-methylprop-2-enoate, 2-[((3-E)octa-3,7-dienyl)methylamino]ethyl 2-methylprop-2-enoate, 28 ((4-Z)octa-4,7-dienyl)methylamino]ethyl 2-methylprop-2-enoate, 2-[(octa-2,6-dienyl)methylamino]ethyl 2-methylprop-2-enoate, 2-[(octa-2,4-dienyl)methylamino]ethyl 2-methylprop-2-enoate, 2-[(octa-3,5-dienyl)methylamino]ethyl 2-methylprop-2-enoate, 2-[((2-E)octa-2,7-dienyl)methylamino]ethyl-(meth)acrylamide, 2-[(2-Z)octa-2,7-dienyl)methylamino]ethyl-(meth)acrylamide, 2-[((3-E)octa-3,7-dienyl)methylamino]ethyl-(meth)acrylamide, 2-[((4-Z)octa-4,7-dienyl)methylamino]ethyl-(meth)acrylamide, 2-[(octa-2,6-dienyl)methylamino]ethyl-(meth)acrylamide, 2-[(octa-2,4-dienyl)methylamino]ethyl-(meth)acrylamide, 2-[(octa-3,5-dienyl)methylamino]ethyl-(meth)acrylamide, 2-[((2-E)octa-2,7-dienyl)ethylamino]ethyl 2-methylprop-2-enoate, 2-[((2-Z)octa-2,7-dienyl)methylamino]ethyl 2-methylprop-2-enoate, 2-[((3-E)octa-3,7-dienyl)ethylamino]ethyl 2-methylprop-2-enoate, 2-[((4-Z)octa-4,7-dienyl)ethylamino]ethyl 2-methylprop-2-enoate, 2-[(octa-2,6-dienyl)ethylamino]ethyl 2-methylprop-2-enoate, 2-[(octa-2,4-dienyl)ethylamino]ethyl 2-methylprop-2-enoate, 2-[(octa-3,5-dienyl)ethylamino]ethyl 2-methylprop-2-enoate, 2-[((2-E)octa-2,7-dienyl)methylamino]ethyl prop-2-enoate, 2-[((2-Z)octa-2,7-dienyl)methylamino]ethyl prop-2-enoate, 2-[((3-E)octa-3,7-dienyl)methylamino]ethyl prop-2-enoate, 2-[((4-Z)octa-4,7-dienyl)methylamino]ethyl prop-2-enoate, 2-[(octa-2,6-dienyl)methylamino]ethyl prop-2-enoate, 2-[(octa-2,4-dienyl)methylamino]ethyl prop-2-enoate, 2-[(octa-3,5-dienyl)methylamino]ethyl prop-2-enoate, 2-((2-E)octa-2,7-dienyloxy)ethyl 2-methylprop-2-enoate, 2-((2-Z)octa-2,7-dienyloxy)ethyl 2-methylprop-2-enoate, 2-((3-E)octa-3,7-dienyloxy)ethyl 2-methylprop-2-enoate, 2-((4-Z)octa-4,7-dienyloxy)ethyl 2-methylprop-2-enoate, 2-(octa-2,6-dienyloxy)ethyl 2-methylprop-2-enoate, 2-(octa-2,4-dienyloxy)ethyl 2-methylprop-2-enoate, 2-(octa-3,5-dienyloxy)ethyl 2-methylprop-2-enoate, 2-((2-E)octa-2,7-dienyloxy)ethyl prop-2-enoate, 2-((2-Z)octa-2,7-dienyloxy)ethyl prop-2-enoate, 2-((3-E)octa-3,7-dienyloxy)ethyl prop-2-enoate, 2-((4-Z)octa-4,7-dienyloxy)ethyl prop-2-enoate, 2-(octa-2,6-dienyloxy)ethyl prop-2-enoate, 2-(octa-2,4-dienyloxy)ethyl prop-2-enoate and 2-(octa-3,5-dienyloxy)ethyl prop-2-enoate.

The above-stated (meth)acrylic monomers of formula (IV) can be obtained in particular by processes in which (meth)acrylic acid or a (meth)acrylate, more particularly methyl (meth)acrylate or ethyl (meth)acrylate is reacted with an alcohol and/or an amine. These reactions have been set out above.

The reactant for reaction with the (meth)acrylic acid or the (meth)acrylate may advantageously conform to the formula (V)

H—X—R³—Y—R⁴ (V),

in which X is oxygen or a group of the formula NR′, in which R′ is hydrogen or a radical having 1 to 6 carbon atoms, R³ is an alkylene group having 1 to 22 carbon atoms, Y is oxygen, sulphur or a group of the formula NR″, in which R″ is hydrogen or a radical having 1 to 6 carbon atoms, and R⁴ is an at least doubly unsaturated radical having at least 8 carbon atoms.

With regard to the definition of preferred radicals R′, R″, R³, Y and R⁴, reference is made to the description of the formula (IV).

The preferred reactants according to formula (V) include (methyl(octa-2,7-dienyl)amino)ethanol, (ethyl(octa-2,7-dienyl)amino)ethanol, 2-octa-2,7-dienyloxyethanol, (methyl(octa-2,7-dienyl)amino)ethylamine, (methyl(octa-3,7-dienyl)amino)ethanol, (ethyl(octa-3,7-dienyl)amino)ethanol, 2-octa-3,7-dienyloxyethanol, (methyl(octa-3,7-dienyl)amino)ethylamine, (methyl(octa-4,7-dienyl)amino)ethanol, (ethyl(octa-4,7-dienyl)amino)ethanol, 2-octa-4,7-dienyloxyethanol, (methyl(octa-4,7-dienyl)amino)ethylamine, (methyl(octa-5,7-dienyl)amino)ethanol, (ethyl(octa-5,7-dienyl)amino)ethanol, 2-octa-5,7-dienyloxyethanol, (methyl(octa-5,7-dienyl)amino)ethylamine, (methyl(octa-2,6-dienyl)amino)ethanol, (ethyl(octa-2,6-dienyl)amino)ethanol, 2-octa-2,6-dienyloxyethanol, (methyl(octa-2,6-dienyl)amino)ethylamine, (methyl(octa-2,5-dienyl)amino)ethanol, (ethyl(octa-2,5-dienyl)amino)ethanol, 2-octa-2,5-dienyloxyethanol, (methyl(octa-2,5-dienyl)amino)ethylamine, (methyl(octa-2,4-dienyl)amino)ethanol, (ethyl(octa-2,4-dienyl)amino)ethanol, 2-octa-2,4-dienyloxyethanol, (methyl(octa-2,4-dienyl)amino)ethylamine, (methyl(octa-3,6-dienyl)amino)ethanol, (ethyl(octa-3,6-dienyl)amino)ethanol, 2-octa-3,6-dienyloxyethanol, (methyl(octa-3,6-dienyl)amino)ethylamine, (methyl(octa-3,5-dienyl)amino)ethanol, (ethyl(octa-3,5-dienyl)amino)ethanol, 2-octa-3,5-dienyloxyethanol, (methyl(octa-3,5-dienyl)amino)ethylamine, (methyl(octa-4,6-dienyl)amino)ethanol, (ethyl(octa-4,6-dienyl)amino)ethanol, 2-octa-4,6-dienyloxyethanol and (methyl(octa-4,6-dienyl)amino)ethylamine. The reactants according to formula (V) may be used individually or as a mixture.

The reactants of formula (V) can be obtained by methods which include known methods of the telomerization of 1,3-butadiene. The term “telomerization” denotes the reaction of compounds having conjugated double bonds in the presence of nucleophiles. The methods set out in publications WO 2004/002931, WO 03/031379 and WO 02/100803, in particular the catalysts used for the reaction and the reaction conditions, such as pressure and temperature, for example, are incorporated for purposes of disclosure into the present specification.

The telomerization of 1,3-butadiene may take place preferably with use of metal compounds comprising metals from groups 8 to 10 of the Periodic Table of the Elements as catalyst, it being possible with particular preference to use palladium compounds, especially palladium carbene complexes, which are set out in more detail in the above-stated publications.

As nucleophiles it is possible to use, in particular, dialcohols, such as ethylene glycol, 1,2-propanediol, 1,3-propanediol; diamines, such as ethylenediamine, N-methylethylenediamine, N,N′-dimethylethylenediamine or hexamethylenediamine; or aminoalkanols, such as aminoethanol, N-methylaminoethanol, N-ethylaminoethanol, aminopropanol, N-methylaminopropanol or N-ethylaminopropanol.

When the nucleophile used is (meth)acrylic acid, octadienyl (meth)acrylates, for example, may be obtained, which are particularly suitable as (meth)acrylic monomers having 8 to 40 carbon atoms.

The temperature at which the telomerization reaction is performed is between 10 and 180° C., preferably between 30 and 120°, more preferably between 40 and 100° C. The reaction pressure is 1 to 300 bar, preferably 1 to 120 bar, more preferably 1 to 64 bar and very preferably 1 to 20 bar.

Isomers of compounds which have an octa-2,7-dienyl group can be prepared by isomerization of the double bonds present in the compounds having an octa-2,7-dienyl group.

The above-stated (meth)acrylic monomers which in the alkyl radical have at least one double bond and 8 to 40 carbon atoms can be used individually or as a mixture of two or more monomers.

Furthermore, the (meth)acrylic polymer for use in accordance with the invention in the coating composition comprises units derived from hydroxyl-containing monomers which have up to 9 carbon atoms.

Hydroxyl-containing monomers are compounds which as well as a carbon-carbon double bond have at least one hydroxyl group. These compounds have preferably 3 to 9, more preferably 4 to 8 and very preferably 5 to 7 carbon atoms. The carbon group of these compounds may be linear, branched or cyclic. Moreover, these compounds may have aromatic or heteroaromatic groups. As well as olefinic alcohols, such as allyl alcohol, for example, these compounds comprise, in particular, unsaturated esters and ethers having a hydroxyl group.

These include preferably (meth)acrylates having a hydroxyl group in the alkyl radical, more particularly 2-hydroxyethyl (meth)acrylate, preferably 2-hydroxyethyl methacrylate (HEMA), hydroxypropyl(meth)acrylate, such as 2-hydroxypropyl(meth)acrylate and 3-hydroxypropyl(meth)acrylate, preferably hydroxypropyl methacrylate (HPMA), hydroxybutyl(meth)acrylate, preferably hydroxybutyl methacrylate (HBMA), 3,4-dihydroxybutyl(meth)acrylate, and glycerol mono(meth)acrylate.

The (meth)acrylate polymer comprises 0.1% to 60%, preferably 5% to 55% and more preferably 10% to 40% by weight of units derived from hydroxyl-containing monomers.

Of particular interest in this context, in particular, are (meth)acrylate polymers which are distinguished by a high weight ratio of units derived from hydroxyl-containing monomers to the units derived from (meth)acrylic monomers which in the alkyl radical have at least one double bond and 8 to 40 carbon atoms. In accordance with one particular aspect, the weight ratio of units derived from hydroxyl-containing monomers to the units derived from (meth)acrylic monomers which in the alkyl radical have at least one double bond and 8 to 40 carbon atoms is preferably greater than 1, more preferably greater than 2. With particular preference, the weight ratio of units derived from hydroxyl-containing monomers to the units derived from (meth)acrylic monomers which in the alkyl radical have at least one double bond and 8 to 40 carbon atoms may be situated in the range from 1:1 to 5:1, more preferably 2:1 to 4:1.

As well as the above-stated (meth)acrylic monomers which in the alkyl radical have at least one double bond and 8 to 40 carbon atoms, and the hydroxyl-containing monomers, (meth)acrylate polymers for use in accordance with the invention may have 0.1% to 95% by weight of units derived from (meth)acrylates having 1 to 12 carbon atoms in the alkyl radical that have no double bonds or heteroatoms in the alkyl radical. Preferred in this context are (meth)acrylates having 1 to 10 carbon atoms in the alkyl radical and having no double bonds or heteroatoms in the alkyl radical.

The (meth)acrylates having 1 to 12 carbon atoms in the alkyl radical that have no double bonds or heteroatoms in the alkyl radical include, among others, (meth)acrylates having a linear or branched alkyl radical, such as, for example, methyl(meth)acrylate, ethyl(meth)acrylate, n-propyl(meth)acrylate, isopropyl(meth)acrylate, n-butyl(meth)acrylate, isobutyl(meth)acrylate, tert-butyl(meth)acrylate and pentyl(meth)acrylate, hexyl(meth)acrylate, 2-ethylhexyl(meth)acrylate, heptyl(meth)acrylate, octyl(meth)acrylate, 3-isopropylheptyl(meth)acrylate, nonyl(meth)acrylate, decyl(meth)acrylate, undecyl(meth)acrylate, 5-methylundecyl(meth)acrylate, dodecyl(meth)acrylate; and cycloalkyl(meth)acrylates, such as cyclopentyl(meth)acrylate, cyclohexyl(meth)acrylate, cyclohexyl(meth)acrylates having at least one substituent on the ring, such as tert-butylcyclohexyl(meth)acrylate and trimethylcyclohexyl(meth)acrylate, norbornyl(meth)acrylate, methylnorbornyl(meth)acrylate and dimethylnorbornyl(meth)acrylate, bornyl(meth)acrylate, 1-adamantyl(meth)acrylate, 2-adamantyl(meth)acrylate, menthyl(meth)acrylate and isobornyl(meth)acrylate. The above-stated (meth)acrylates having 1 to 12 carbon atoms in the alkyl radical may be used individually or as a mixture.

Surprising advantages are manifested in particular by (meth)acrylate polymers which have preferably 5% to 90%, more preferably 10% to 70% and very preferably 20% to 60% by weight of units derived from (meth)acrylates having 1 to 12 carbon atoms in the alkyl radical and containing no double bonds or heteroatoms in the alkyl radical, based on the weight of the (meth)acrylate polymer.

Further of particular interest are (meth)acrylate polymers which comprise preferably 1% to 50% by weight, more preferably 5% to 40% by weight, of units derived from cycloalkyl(meth)acrylates, more particular from cyclohexyl methacrylate, cyclohexyl acrylate, cyclohexyl(meth)acrylates having at least one substituent on the ring, such as tert-butylcyclohexyl methacrylate and trimethylcyclohexyl(meth)acrylate, preferably 2,4,6-trimethylcyclohexyl methacrylate, isobornyl acrylate and/or isobornyl methacrylate.

In one particular aspect of the present invention, the above-stated (meth)acrylates having 1 to 12 carbon atoms in the alkyl radical that contain no double bonds or heteroatoms in the alkyl radical may be selected such that a (meth)acrylate polymer composed of these (meth)acrylates having 1 to 12 carbon atoms in the alkyl radical has a glass transition temperature of at least 40° C., preferably at least 50° C. and more preferably at least 60° C.

The glass transition temperature, Tg, of the polymer may be determined in a known way by means of Differential Scanning Calorimetry (DSC), in particular in accordance with DIN EN ISO 11357. The glass transition temperature may be determined preferably as the mid-point of the glass stage of the second heating curve, with a heating rate of 10° C. per minute. Furthermore, the glass transition temperature Tg may also be calculated approximately in advance by means of the Fox equation. According to Fox T. G., Bull. Am. Physics Soc. 1, 3, page 123 (1956), it holds that:

$$\frac{1}{Tg} = \frac{{x}_{1}}{{Tg}_{1}} + \frac{{x}_{2}}{{Tg}_{2}} + … + \frac{{x}_{n}}{{Tg}_{n}}$$

where xₙ is the mass fraction (% by weight/100) of the monomer n and Tgₙ is the glass transition temperature in kelvins of the homopolymer of the monomer n. Further useful information can be found by the skilled person in the Polymer Handbook 2^{nd} Edition, J. Wiley & Sons, New York (1975), which reports Tg values for the most familiar homopolymers. According to that handbook, for example, poly(methyl methacrylate) has a glass transition temperature of 378 K, poly(butyl methacrylate) one of 297 K, poly(isobornyl methacrylate) one of 383 K, poly(isobornyl acrylate) one of 367 K and poly(cyclohexyl methacrylate) one of 356 K. To determine the glass transition temperature, the polymer composed of (meth)acrylates having 1 to 12 carbon atoms in the alkyl radical that have no double bonds or heteroatoms in the alkyl radical may have a weight-average molecular weight of at least 100 000 g/mol and a number-average molecular weight of at least 80 000 g/mol.

The nature and amount of the above-stated (meth)acrylates having 1 to 12 carbon atoms in the alkyl radical that have no double bonds or heteroatoms in the alkyl radical may be selected via the above-stated formula of Fox et al.

The (meth)acrylate polymer of the present invention further comprises 0.1% to 60% by weight of units derived from styrene monomers, based on the weight of the (meth)acrylate polymer.

Styrene monomers are known in the art. These monomers include, for example, styrene. substituted styrenes having an alkyl substituent in the side chain, such as α-methylstyrene and α-ethylstyrene, substituted styrenes having an alkyl substituent on the ring, such as vinyltoluene and p-methylstyrene, and halogenated styrenes, such as monochlorostyrenes, dichlorostyrenes, tribromostyrenes and tetrabromostyrenes, for example.

In one particular modification of the present invention, the (meth)acrylate polymer may have 1% to 55%, more preferably 5% to 50% and very preferably 10% to 40% by weight of units derived from styrene monomers, more particularly from styrene, substituted styrenes having an alkyl substituent in the side chain, substituted styrenes having an alkyl substituent on the ring and/or halogenated styrenes, based on the total weight of the (meth)acrylate polymer.

In addition to the obligatory repeating units set out above, the (meth)acrylate polymer may comprise units derived from comonomers. These comonomers differ from the above-stated units of the polymer, but can be copolymerized with the above-stated monomers. The (meth)acrylate polymer preferably comprises not more than 30% by weight, more preferably not more than 15% by weight, of units derived from comonomers.

One group of preferred comonomers have an acid group. Monomers containing acid groups are compounds which can be copolymerized preferably free-radically with the above-stated (meth)acrylic monomers. They include, for example, monomers with a sulphonic acid group, such as vinylsulphonic acid; monomers with a phosphonic acid group, such as vinylphosphonic acid; and unsaturated carboxylic acids, such as methacrylic acid, acrylic acid, fumaric acid and maleic acid, for example. Methacrylic acid and acrylic acid are particularly preferred. The monomers containing acid groups can be used individually or as a mixture of two, three or more monomers containing acid groups.

Of particular interest are, in particular, (meth)acrylate polymers which have 0% to 10%, preferably 0.5% to 8% and more preferably 1% to 5% by weight of units derived from monomers containing acid groups, based on the total weight of the (meth)acrylate polymer.

Another class of comonomers are (meth)acrylates having at least 13 carbon atoms in the alkyl radical and deriving from saturated alcohols, such as, for example, 2-methyldodecyl(meth)acrylate, tridecyl(meth)acrylate, 5-methyltridecyl(meth)acrylate, tetradecyl(meth)acrylate, pentadecyl(meth)acrylate, hexadecyl(meth)acrylate, 2-methylhexadecyl(meth)acrylate, heptadecyl(meth)acrylate, 5-isopropylheptadecyl(meth)acrylate, 4-tert-butyloctadecyl(meth)acrylate, 5-ethyloctadecyl(meth)acrylate, 3-isopropyloctadecyl(meth)acrylate, octadecyl(meth)acrylate, nonadecyl(meth)acrylate, eicosyl(meth)acrylate, cetyleicosyl(meth)acrylate, stearyleicosyl(meth)acrylate, docosyl(meth)acrylate and/or eicosyltetratriacontyl(meth)acrylate;

cycloalkyl(meth)acrylates, such as 2,4,5-tri-tert-butyl-3-vinylcyclohexyl(meth)acrylate, 2,3,4,5-tetra-tert-butylcyclohexyl(meth)acrylate;

heterocyclic(meth)acrylates, such as 2-(1-imidazolyl)ethyl(meth)acrylate, 2-(4-morpholinyl)ethyl(meth)acrylate, 1-(2-methacryloyloxyethyl)-2-pyrrolidone;

nitriles of (meth)acrylic acid and other nitrogen-containing methacrylates, such as N-(methacryloyloxyethyl)diisobutylketimine, N-(methacryloyloxyethyl)dihexadecylketimine, methacryloylamidoacetonitrile, 2-methacryloyloxyethylmethylcyanamide, cyanomethyl methacrylate;

aryl(meth)acrylates, such as benzyl (meth)acrylate or phenyl (meth)acrylate, it being possible for each of the aryl radicals to be unsubstituted or substituted up to four times;

polyalkoxylated derivatives of (meth)acrylic acid, especially polypropylene glycol mono(meth)acrylate having 2 to 10, preferably 3 to 6, propylene oxide units, preferably polypropylene glycol monomethacrylate having about 5 propylene oxide units (PPM5), polyethylene glycol mono(meth)acrylate having 2 to 10, preferably 3 to 6, ethylene oxide units, preferably polyethylene glycol monomethacrylate having about 5 ethylene oxide units (PEM5), polybutylene glycol mono(meth)acrylate, polyethylene glycolpolypropylene glycol mono(meth)acrylate;

(meth)acrylamides, especially N-methylol(meth)acrylamide, N,N-dimethylaminopropyl(meth)acrylamide, tert-butylaminoethyl methacrylate, methacrylamide and acrylamide;

and

(meth)acrylates which derive from saturated fatty acids or fatty acid amides, such as (meth)acryloyloxy-2-hydroxypropyl-palmitic acid ester, (meth)acryloyloxy-2-hydroxypropyl-stearic acid ester and (meth)acryloyloxy-2-hydroxypropyl-lauric ester, pentadecyloyloxy-2-ethyl-(meth)acrylamide, heptadecyloyloxy-2-ethyl-(meth)acrylamide, (meth)acryloyloxy-2-ethyl-lauramide, (meth)acryloyloxy-2-ethyl-myristamide, (meth)acryloyloxy-2-ethyl-palmitamide, (meth)acryloyloxy-2-ethyl-stearamide, (meth)acryloyloxy-2-propyl-lauramide, (meth)acryloyloxy-2-propyl-myristamide, (meth)acryloyloxy-2-propyl-palmitamide and (meth)acryloyloxy-2-propyl-stearamide.

The comonomers further include vinyl esters, such as vinyl acetate, vinyl chloride, vinyl versatate, ethylene-vinyl acetate, ethylene-vinyl chloride;

maleic acid derivatives, such as maleic anhydride, esters of maleic acid, such as dimethyl maleate, methylmaleic anhydride; and

fumaric acid derivatives, such as dimethyl fumarate.

Heterocyclic vinyl compounds, such as 2-vinylpyridine, 3-vinylpyridine, 2-methyl 5-vinylpyridine, 3-ethyl 4-vinylpyridine, 2,3-dimethyl-5-vinylpyridine, vinylpyrimidine, vinylpiperidine, 9-vinylcarbazole, 3-vinylcarbazole, 4-vinylcarbazole, 1-vinylimidazole, 2-methyl 1-vinylimidazole, N-vinylpyrrolidone, 2-vinylpyrrolidone, N-vinylpyrrolidine, 3-vinylpyrrolidine, N-vinylcaprolactam, N-vinylbutyrolactam, vinyloxolane, vinylfuran, vinylthiophene, vinylthiolane, vinylthiazoles and hydrogenated vinylthiazoles,

vinyloxazoles and hydrogenated vinyloxazoles;

maleimide, methylmaleimide;

vinyl and isoprenyl ethers; and

vinyl halides, such as, for example, vinyl chloride, vinyl fluoride, vinylidene chloride and vinylidene fluoride represent further examples of comonomers.

Preference for preparing the (meth)acrylic polymer is given, moreover, to monomer mixtures which have a very small fraction of (meth)acrylates having two or more carbon-carbon double bonds with a reactivity identical to that of a (meth)acryloyl group. In one particular modification of the present invention the fraction of compounds having two or more (meth)acryloyl groups is preferably confined to not more than 5% by weight, more particularly not more than 2% by weight, with particular preference not more than 1% by weight, more preferably not more than 0.5% by weight and very preferably not more than 0.1% by weight, based on the total weight of the monomers.

The (meth)acrylate polymer of the invention has a weight-average molecular weight in the range from 2000 g/mol to 60 000 g/mol, preferably in the range from 4000 g/mol to 40 000 g/mol and more preferably in the range from 5000 g/mol to 20 000 g/mol. The number-average molecular weight of preferred (meth)acrylate polymers is in the range from 1000 to 50 000 g/mol, more preferably in the range from 1500 to 10 000 g/mol. Also of particular interest are (meth)acrylic polymers which have a polydispersity index, M_{w}/Mₙ, in the range from 1 to 5, more preferably in the range from 1.5 to 3. The molecular weight can be determined by means of gel permeation chromatography (GPC) against a PMMA standard.

In one particular aspect of the present invention the (meth)acrylate polymer may have a molecular weight distribution having at least 2 maxima, as measured by gel permeation chromatography.

The glass transition temperature of the (meth)acrylate polymer is preferably in the range from 20° C. to 90° C., more preferably in the range from 25 to 85° C. and very preferably in the range from 30 to 80° C. The glass transition temperature may be influenced via the nature and proportion of the monomers used for preparing the (meth)acrylate polymer. The glass transition temperature Tg of the (meth)acrylic polymer may be determined in a known way by means of Differential Scanning Calorimetry (DSC), more particularly in accordance with DIN EN ISO 11357. The glass transition temperature may be determined with preference as the mid-point of the glass stage of the second heating curve, with a heating rate of 10° C. per minute. Furthermore, the glass transition temperature Tg may also be calculated approximately in advance by means of the above-described Fox equation.

The iodine number of (meth)acrylate polymers for preferred use is preferably in the range from 1 to 300 g iodine per 100 g polymer, preferably in the range from 2 to 250 g iodine per 100 g polymer, more preferably 5 to 100 g iodine per 100 g polymer, and very preferably 10 to 50 g iodine per 100 g polymer, measured in accordance with DIN 53241-1.

The hydroxyl number of the polymer may be situated preferably in the range from 3 to 300 mg KOH/g, more preferably 20 to 200 mg KOH/g and very preferably in the range from 40 to 150 mg KOH/g. The hydroxyl number may be determined in accordance with DIN EN ISO 4629.

The (meth)acrylate polymers for use in accordance with the invention may be obtained in particular by solution polymerizations, bulk polymerizations or emulsion polymerizations, it being possible to achieve surprising advantages by means of a radical solution polymerization. These methods are set out in Ullmann's Encyclopedia of Industrial Chemistry, Sixth Edition.

As well as methods of conventional radical polymerization it is also possible to employ related methods of controlled radical polymerization, such as, for example, ATRP (=Atom Transfer Radical Polymerization), NMP (Nitroxide-mediated Polymerization) or RAFT (=Reversible Addition Fragmentation Chain Transfer) to prepare the polymers. Typical free radical polymerization is carried out using a polymerization initiator and possibly also, in many cases, a molecular weight regulator.

The initiators which can be used include, among others, the initiators that are widely known in the art and are azo initiators, such as AIBN and 1,1-azobiscyclohexanecarbonitrile, and also peroxy compounds, such as methyl ethyl ketone peroxide, acetylacetone peroxide, dilauryl peroxide, tert-butyl per-2-ethylhexanoate, ketone peroxide, tert-butyl peroctoate, methyl isobutyl ketone peroxide, cyclohexanone peroxide, dibenzoyl peroxide, tert-butyl peroxybenzoate, tert-butylperoxyisopropyl carbonate, 2,5-bis(2-ethylhexanoylperoxy)-2,5-dimethylhexane, tert-butylperoxy-2-ethylhexanoate, tert-butylperoxy-3,5,5-trimethylhexanoate, dicumyl peroxide, 1,1-bis(tert-butylperoxy)cyclohexane, 1,1-bis(tert-butylperoxy)-3,3,5-trimethylcyclohexane, cumyl hydroperoxide, tert-butyl hydroperoxide, bis(4-tert-butylcyclohexyl) peroxydicarbonate, mixtures of two or more of the aforementioned compounds with one another, and mixtures of the aforementioned compounds with nonspecified compounds that may likewise form free radicals.

The stated initiators may be used either individually or in a mixture. They are used preferably in an amount of 0.05% to 10.0% by weight, more preferably 3% to 8% by weight, based on the total weight of the monomers. It is also possible with preference to carry out the polymerization using a mixture of different polymerization initiators having different half-lives.

The sulphur-free molecular weight regulators include, for example—without any intention hereby to impose any restriction—dimeric α-methylstyrene (2,4-diphenyl-4-methyl-1-pentene), enol ethers of aliphatic and/or cycloaliphatic aldehydes, terpenes, β-terpinene, terpinolene, 1,4-cyclohexadiene, 1,4-dihydronaphthalene, 1,4,5,8-tetrahydronaphthalene, 2,5-dihydrofuran, 2,5-dimethylfuran and/or 3,6-dihydro-2H-pyran; dimeric α-methylstyrene is preferred.

As sulphur-containing molecular weight regulators it is possible with preference to use mercapto compounds, dialkyl sulphides, dialkyl disulphides and/or diaryl sulphides. The following polymerization regulators are specified by way of example: di-n-butyl sulphide, di-n-octyl sulphide, diphenyl sulphide, thiodiglycol, ethylthioethanol, diisopropyl disulphide, di-n-butyl disulphide, di-n-hexyl disulphide, diacetyl disulphide, diethanol sulphide, di-tert-butyl trisulphide and dimethyl sulphoxide. Preferred compounds used as molecular weight regulators are mercapto compounds, dialkyl sulphides, dialkyl disulphides and/or diaryl sulphides. Examples of these compounds are ethyl thioglycolate, 2-ethylhexyl thioglycolate, cysteine, 2-mercaptoethanol, 3-mercaptopropanol, 3-mercaptopropane-1,2-diol, 1,4-mercaptobutanol, mercaptoacetic acid, 3-mercaptopropionic acid, mercaptosuccinic acid, thioglycerol, thioacetic acid, thiourea and alkyl mercaptans such as n-butyl mercaptan, n-hexyl mercaptan or n-dodecyl mercaptan. Polymerization regulators used with particular preference are mercaptoalcohols and mercaptocarboxylic acids.

The molecular weight regulators are used preferably in amounts of 0.05% to 10%, more preferably 0.1% to 5% by weight and very preferably in the range from 0.5% to 3%, based on the monomers used in the polymerization. In the polymerization it is of course also possible to employ mixtures of polymerization regulators.

The polymerization can be carried out under atmospheric, subatmospheric or superatmospheric pressure. The polymerization temperature as well is not critical. Generally speaking, however, it is in the range of −20°-200° C., preferably 50°-150° C. and more preferably 80°-130° C.

The polymerization can be carried out with or without solvent. The term “solvent” should be understood widely in this context. The preferred solvents include, in particular, aromatic hydrocarbons, such as toluene, xylene; esters, especially acetates, preferably butyl acetate, ethyl acetate, propyl acetate; ketones, preferably ethyl methyl ketone, acetone, methyl isobutyl ketone or cyclohexanone; alcohols, especially isopropanol, n-butanol, isobutanol; ethers, especially glycol monomethyl ethers, glycol monoethyl ethers, glycol monobutyl ethers; aliphatics, preferably pentane, hexane, cycloalkanes and substituted cycloalkanes, such as cyclohexane; mixtures of aliphatics and/or aromatics, preferably naphtha; benzine, biodiesel; but also plasticizers such as low molecular weight polypropylene glycols or phthalates.

Of particular interest are, in particular, coating compositions which comprise preferably 40% to 80% by weight, more preferably 50% to 75% by weight of at least one (meth)acrylic polymer with units derived from (meth)acrylic monomers which in the alkyl radical have at least one double bond and 8 to 40 carbon atoms.

The coating compositions or (meth)acrylate polymers of the invention may be crosslinked in particular by crosslinking agents which are able to react with the hydroxyl groups of the polymer.

The present polymers with hydroxyl groups may be crosslinked, for example, using compounds which have two or more N-methylolamide groups, such as, for example, polymers with repeating units derived from N-methylolmethacrylamide. For the crosslinking it is usual to employ temperatures of at least 100° C., preferably at least 120° C.

Furthermore, the polymers of the invention with hydroxyl groups may be crosslinked using polyanhydrides, such as dianhydrides, for example, especially pyromellitic dianhydride, or polymers having two or more units derived from maleic anhydride. Crosslinking with polyanhydrides may take place preferably at an elevated temperature of, for example, at least 100° C., preferably at least 120° C.

A further class of crosslinking agents are melamine or urea derivatives. Crosslinking with melamine or urea derivatives may take place preferably at an elevated temperature of, for example, at least 100° C., preferably at least 120° C.

The preferred crosslinking agents include, in particular, polyisocyanates or compounds which liberate polyisocyanates. Polyisocyanates are compounds having at least 2 isocyanate groups.

The polyisocyanates which can be used in accordance with the invention may comprise any desired aromatic, aliphatic, cycloaliphatic and/or (cyclo)aliphatic polyisocyanates.

The preferred aromatic polyisocyanates include 1,3- and 1,4-phenylene diisocyanate, 1,5-naphthylene diisocyanate, tolidine diisocyanate, 2,6-tolylene diisocyanate, 2,4-tolylene diisocyanate (2,4-TDI), 2,4′-diphenylmethane diisocyanate (2,4′-MDI), 4,4′-diphenylmethane diisocyanate, the mixtures of monomeric diphenylmethane diisocyanates (MDI) and oligomeric diphenylmethane diisocyanates (polymeric MDI), xylylene diisocyanate, tetramethylxylylene diisocyanate and triisocyanatotoluene.

Preferred aliphatic polyisocyanates possess 3 to 16 carbon atoms, preferably 4 to 12 carbon atoms, in the linear or branched alkylene radical, and suitable cycloaliphatic or (cyclo)aliphatic diisocyanates possess advantageously 4 to 18 carbon atoms, preferably 6 to 15 carbon atoms, in the cycloalkylene radical. By (cyclo)aliphatic diisocyanates the skilled person adequately understands NCO groups attached, simultaneously, cyclically and aliphatically, as is the case, for example, in isophorone diisocyanate. In contrast, cycloaliphatic diisocyanates are understood to be those which contain NCO groups only attached directly to the cycloaliphatic ring, e.g. H₁₂MDI. Examples are cyclohexane diisocyanate, methylcyclohexane diisocyanate, ethylcyclohexane diisocyanate, propylcyclohexane diisocyanate, methyldiethylcyclohexane diisocyanate, propane diisocyanate, butane diisocyanate, pentane diisocyanate, hexane diisocyanate, heptane diisocyanate, octane diisocyanate, nonane diisocyanate, nonane triisocyanate, such as 4-isocyanatomethyl-1,8-octane diisocyanate (TIN), decane diisocyanate and triisocyanate, undecane diisocyanate and triisocyanate, and dodecane diisocyanates and triisocyanates.

Preference is given to isophorone diisocyanate (IPDI), hexamethylene diisocyanate (HDI), diisocyanatodicyclohexylmethane (H₁₂MDI), 2-methylpentane diisocyanate (MPDI), 2,2,4-trimethylhexamethylene diisocyanate/2,4,4-trimethylhexamethylene diisocyanate (TMDI), norbornane diisocyanate (NBDI). Especial preference is given to using IPDI, HDI, TMDI and H₁₂MDI, it also being possible to employ the isocyanurates.

Likewise suitable are 4-methylcyclohexane 1,3-diisocyanate, 2-butyl-2-ethylpentamethylene diisocyanate, 3(4)-isocyanatomethyl-1-methylcyclohexyl isocyanate, 2-isocyanatopropylcyclohexyl isocyanate, 2,4′-methylene-bis(cyclohexyl)diisocyanate, 1,4-diisocyanato-4-methylpentane.

Preferred aliphatic, cycloaliphatic and araliphatic, i.e. aryl-substituted aliphatic, diisocyanates are described for example in Houben-Weyl, Methoden der organischen Chemie, Volume 14/2, pages 61-70 and in the article by W. Siefken, Justus Liebigs Annalen der Chemie 562, 75-136.

It is of course also possible to use mixtures of the polyisocyanates.

Furthermore, preferably, oligoisocyanates or polyisocyanates are used which can be prepared from the stated diisocyanates or polyisocyanates, or mixtures thereof, by linkage by means of urethane, allophanate, urea, biuret, uretdione, amide, isocyanurate, carbodiimide, uretonimine, oxadiazinetrione or iminooxadiazinedione structures. This preferred class of polyisocyanates comprises compounds which are prepared by dimerization, trimerization, allophanatization, biuretization and/or urethanization of the simple diisocyanates and which have more than two isocyanate groups per molecule, examples being the reaction products of these simple diisocyanates, such as IPDI, TMDI, HDI and/or H₁₂MDI, for example, with polyhydric alcohols (e.g. glycerol, trimethylolpropane, pentaerythritol) or polyfunctional polyamines, or the triisocyanurates obtained by trimerization of the simple diisocyanates, such as IPDI, HDI and H₁₂MDI, for example.

Of particular interest, therefore, are coating materials which contain preferably 0.5% to 10% by weight, more preferably 2% to 7% by weight, of crosslinking agent(s). Where polyisocyanates are used as crosslinking agents, the reaction of the (meth)acrylate polymers with the organic polyisocyanates may in this case be carried out, depending on the intended use of the reaction products, with 0.5 to 1.1 NCO group per hydroxyl group. The reaction is preferably carried out such that the amounts of the organic polyisocyanate, based on the total hydroxyl content of the components present in the reaction mixture, per hydroxyl group, are present in an amount of 0.7 to 1.0 isocyanate group.

The coating materials of the invention do not require any siccatives, although the latter may be present in the compositions as an optional ingredient. Such siccatives include, in particular, organometallic compounds, examples being metal soaps of transition metals, such as cobalt, manganese, lead, zirconium, iron, cerium; alkali metals or alkaline earth metals, such as lithium, potassium and calcium, for example. Examples that may be mentioned include cobalt naphthalate and cobalt acetate. The siccatives can be used individually or as a mixture, particular preference being given more particularly to mixtures comprising cobalt salts, zirconium salts and lithium salts.

The proportion of siccatives in preferred coating materials may be situated preferably in the range from greater than 0% to 5% by weight, more preferably in the range from greater than 0% to 3% by weight and very preferably in the range from greater than 0% to 0.1% by weight, based on the weight of the polymer.

As well as the (meth)acrylate polymers of the invention, the coating compositions of the invention may comprise solvent(s). Examples of preferred solvents have been set out above in connection with a radical polymerization, and so reference is made thereto. The proportion of solvent in preferred coating materials may be situated in particular in the range from 0% to 60%, more preferably in the range from 5% to 40% by weight, based on the total weight of the coating composition.

The coating materials of the invention may further comprise customary auxiliaries and adjuvants such as rheology modifiers, defoamers, water scavengers (moisture-removing additives, ortho esters), deaerating agents, pigment wetting agents, dispersing additives, substrate wetting agents, lubricant and flow-control additives, which may preferably be present in each case in an amount from 0% by weight to 3% by weight, based on the overall formula, and also water repellents, plasticizers, diluents, especially reactive diluents, UV stabilizers and adhesion promoters, which may preferably be present each in an amount from 0% by weight to 20% by weight, based on the overall formula.

Furthermore, the coating materials of the invention may be admixed with customary fillers and pigments, such as talc, calcium carbonate, titanium dioxide, carbon black, etc., in an amount up to 50% by weight of the overall composition.

The coating materials of the invention feature an outstanding spectrum of properties, which includes in particular outstanding processing properties in tandem with excellent quality in the resultant coating. Preferred coating materials can be processed within a wide temperature window, spanning preferably a breadth of at least 20° C., more particularly at least 30° C., without detriment to the quality of the coating, which is distinguished in particular by high solvent resistance and water resistance. A preferred coating material can be processed, accordingly, at a temperature of 15° C., 20°, 30° C. or 40° C., without any substantial, measurable deterioration in quality.

The dynamic viscosity of the coating material is dependent on the solids content and on the nature of the solvent, whose use is optional, and it may span a wide range. In the case of a high polymer content, it may amount to more than 20 000 mPas. Usually advantageous is a dynamic viscosity in the range from 10 to 10 000 mPas, preferably 100 to 8000 mPas and very preferably 1000 to 6000 mPas, measured in accordance with DIN EN ISO 2555 at 25° C. (Brookfield).

Surprisingly good processing properties are displayed, furthermore, by coating materials whose solids content is preferably at least 50% by weight, more preferably at least 60% by weight.

For a given solids content, the coating materials of the invention can be processed over a substantially broader temperature range than existing coating materials. With comparable processing properties, the coating materials of the invention are notable for a surprisingly high solids content, and so the coating materials of the invention are particularly eco-friendly.

Furthermore, the present invention provides a method of producing a coating, in which a coating composition of the invention is applied to a substrate and cured.

The coating composition of the invention can be applied by customary application techniques, such as dipping, rolling, flowcoating and pouring methods, more particularly by spreading, roller-coating and spraying methods (high-pressure, low-pressure, airless or electrostatic (ESTA)). The coating material is cured by drying and by oxidative crosslinking by means of atmospheric oxygen. In one particular aspect of the present invention a crosslinking may be carried out with a crosslinking agent, more particularly with a polyisocyanate.

The substrates preferably providable with a coating material of the invention include, in particular, metals, especially iron and steel, zinc and galvanized steels, and also plastics and concrete substrates.

Furthermore, the present invention provides coated articles obtainable by a method of the invention. The coating of these articles is distinguished by an outstanding spectrum of properties.

Preferred coatings obtained from the coating materials of the invention exhibit a high mechanical stability. The pendulum hardness is preferably at least 30 s, more preferably at least 50 s and very preferably at least 100 s, measured in accordance with DIN ISO 1522.

Furthermore, preferred coatings obtainable from the coating materials of the invention have a surprisingly strong adhesion, as can be determined, in particular, by the cross-cut test. Hence it is possible in particular to achieve a classification of 0-1, more preferably of 0, in accordance with the standard DIN EN ISO 2409.

The coatings obtainable from the coating materials of the invention generally exhibit a high solvent resistance, with only small fractions being dissolved from the coating by solvents, in particular. Preferred coatings are outstandingly resistant to polar solvents in particular, especially alcohols, such as 2-propanol, or ketones, such as methyl ethyl ketone (MEK), and to non-polar solvents, such as diesel fuel (alkanes), for example. Following exposure for 15 minutes with subsequent drying (24 hours at room temperature), preferred coatings in accordance with the present invention have a pendulum hardness in accordance with DIN ISO 1522 of at least 90 s, preferably at least 100 s. Furthermore, the coating materials of the invention may be formulated so as to exhibit high resistance towards acids and bases.

Furthermore, preferred coatings display surprisingly good cupping. In particular modifications of the present invention, coatings exhibit a cupping of at least 4.5 mm, more preferably at least 5 mm, as measured in accordance with DIN 53156 (Erichsen).

The present invention is illustrated below with reference to inventive and comparative examples, without any intention that this should constitute a restriction.

Preparation of a mixture of methacryloyloxy-2-ethyl-fatty acid amides (MUMA)

A four-necked round-bottomed flask equipped with a sabre stirrer with stirring sleeve and stirring motor, nitrogen inlet, liquid-phase thermometer and a distillation bridge, was charged with 206.3 g (0.70 mol) of fatty acid methyl ester mixture, 42.8 g (0.70 mol) of ethanolamine and 0.27 g (0.26%) of LiOH. The fatty acid methyl ester mixture comprised 6% by weight of saturated C12 to C16 fatty acid methyl esters, 2.5% by weight of saturated C17 to C20 fatty acid methyl esters, 52% by weight of monounsaturated C18 fatty acid methyl esters, 1.5% by weight of monounsaturated C20 to C24 fatty acid methyl esters, 36% by weight of polyunsaturated C18 fatty acid methyl esters and 2% by weight of polyunsaturated C20 to C24 fatty acid methyl esters.

The reaction mixture was heated to 150° C. Over the course of 2 hours, 19.5 ml of methanol were removed by distillation. The resulting reaction product contained 86.5% of fatty acid ethanolamides. The reaction mixture obtained was processed further without purification.

After cooling had taken place, 1919 g (19.2 mol) of methyl methacrylate, 3.1 g of LiOH and an inhibitor mixture consisting of 500 ppm of hydroquinone monomethyl ether and 500 ppm of phenothiazine were added.

With stirring, the reaction apparatus was flushed with nitrogen for 10 minutes.

Thereafter the reaction mixture was heated to boiling. The methyl methacrylate/methanol azeotrope was separated off and then the overhead temperature was raised in steps to 100° C. When the reaction was at an end, the reaction mixture was cooled to about 70° C. and filtered.

Excess methyl methacrylate was separated off on a rotary evaporator. This gave 370 g of product.

### INVENTIVE EXAMPLE 1

A reaction vessel was charged with 50.01 g of solvent (Solvesso 100) and this initial charge was heated to 140° C. Oxygen in the reaction vessel was removed by introduction of nitrogen. Subsequently a reaction mixture containing 15.33 g of di-tert-butyl peroxide (DTBP), 41.15 g of isobornyl methacrylate (IBOMA), 61.73 g of hydroxyethyl methacrylate (HEMA), 20.58 g of ethylhexyl methacrylate (EHMA), 20.58 g of methacryloyloxy-2-ethyl-fatty acid amide (MUMA), 61.73 g of styrene and 3.69 g of 2-mercaptoethanol was added over a period of 4 hours. Thereafter the reaction was continued with stirring for 30 minutes. After that the mixture was cooled to 80° C. The reaction was completed by addition of a mixture comprising 0.21 g of di-tert-butyl peroxide (DTBP) and 15 g of solvent (Solvesso 100), followed by a further 2 hours of stirring at 80° C. Subsequently, stirring was continued for 30 minutes more without heating.

The polymer content was adjusted to 65% by addition of 46.16 g of n-butyl acetate.

The properties of the resulting coating material were investigated. For this purpose a film with a thickness of approximately 50 μm was formed on an aluminium plate, the polymer film being crosslinked by addition of polyisocyanate (hexamethylene diisocyanate, HDI 50/60 NCO/OH) and dibutyltin dilaurate (DBTL, 0.01% by weight, based on the polymer weight).

The hardness and scratch resistance of the crosslinked polymer film were investigated by determination of the pendulum hardness. The chemical resistance was investigated by treating the polymer film with methyl ethyl ketone. The pendulum hardness of the film was then measured. The criterion used here, in particular, is any softening of the film as a result of the treatment with the solvent. The brittleness of the film was investigated by means of Erichsen cupping tests. In addition, the strength of adhesion of the coating was determined by a cross-cut test.

The results obtained are set out in Table 1.

### COMPARATIVE EXAMPLE 1

A reaction vessel was charged with 100.02 g of solvent (Solvesso 100) and this initial charge was heated to 140° C. Oxygen in the reaction vessel was removed by introduction of nitrogen. Subsequently a reaction mixture containing 30.66 g of di-tert-butyl peroxide (DTBP), 82.31 g of isobornyl methacrylate (IBOMA), 123.46 g of hydroxyethyl methacrylate (HEMA), 82.31 g of ethylhexyl methacrylate (EHMA), 123.46 g of styrene and 7.38 g of 2-mercaptoethanol was added over a period of 4 hours. Thereafter the reaction was continued with stirring for 30 minutes. After that the mixture was cooled to 80° C. Reaction was completed by addition of a mixture comprising 0.42 g of di-tert-butyl peroxide (DTBP) and 10 g of solvent (Solvesso 100), followed by a further 2 hours of stirring at 80° C. Subsequently, a further 40 g of solvent (Solvesso 100) were added, and stirring was continued for 30 minutes more without heating.

The polymer content was adjusted to 65% by addition of 92.31 g of n-butyl acetate.

From the resulting coating material a film was produced in accordance with the method set out in Inventive Example 1. The properties of the coatings obtained were determined using the investigation methods set out above, the results obtained being set out in Table 1.

TABLE 1
Properties of the coating compositions investigated

| | Inventive Example 1 | Comparative Example 1 |
|---|---|---|
| IBOMA [% by weight] | 20 | 20 |
| HEMA [% by weight] | 30 | 30 |
| EHMA [% by weight] | 10 | 20 |
| MUMA [% by weight] | 10 | — |
| Styrene [% by weight] | 30 | 30 |
| Solids content [% by | 65 | 65 |
| weight] | | |
| Solvent [% by weight] | 35 | 35 |
| Pendulum hardness [s] | 192 | 186 |
| MEK resistance by | 112 | 84 |
| pendulum hardness [s] | | |
| Indentation [mm] | 5.4 | 5.3 |
| Cross-cut [Gt] | 0 | 0 |

The examples set out above show that the coatings consistently have a very good pendulum hardness, strong adhesion and relatively low brittleness (cupping test).

Surprisingly, the (meth)acrylate polymers which contain MUMA exhibit a somewhat higher pendulum hardness, despite the fact that the number of carbon atoms in the alkyl radical of the methacrylate is much greater than in EHMA. Of particular interest here is the decrease in brittleness. Moreover, the (meth)acrylate polymers containing MUMA display a significantly increased solvent resistance with respect to polar solvents.

1. A multi-functional (meth)acrylate polymer, comprising:
0.5% to 20% by weight of a unit derived from a (meth)acrylic monomer wherein an alkyl radical of the monomer comprise at least one double bond and 8 to 40 carbon atoms;
0.1% to 60% by weight of a unit derived from a hydroxyl-comprising monomer comprising up to 9 carbon atoms;
0.1% to 95% by weight of a unit derived from a (meth)acrylate comprising 1 to 12 carbon atoms in the alkyl radical; and
0.1% to 60% by weight of a unit derived from a styrene monomer,
wherein each case is based on a weight of the multi-functional (meth)acrylate polymer, and
wherein the multi-functional (meth)acrylate polymer has a weight-average molecular weight in a range of from 2000 to 60 000 g/mol as determined by gel permeation chromatography (GPC) against a PMMA standard.

2. The multi-functional (meth)acrylate polymer of claim 1, wherein the weight ratio of the unit derived from the hydroxyl-comprising monomer to the unit derived from the (meth)acrylic monomer wherein the alkyl radical comprise at least one double bond and 8 to 40 carbon atoms is greater than 1.

3. The multi-functional (meth)acrylate polymer of claim 1, wherein the multi-functional (meth)acrylate polymer has a unit derived from a (meth)acrylate comprising a hydroxyl group in the alkyl radical.

4. The multi-functional (meth)acrylate polymer of claim 1, wherein the multi-functional (meth)acrylate polymer comprises 5% to 40% by weight of a unit derived from a cycloalkyl (meth)acrylate.

5. The multi-functional (meth)acrylate polymer of claim 4, further comprising, a unit derived from at least one selected from the group consisting of a cyclohexyl methacrylate and an isobornyl methacrylate.

6. The multi-functional (meth)acrylate polymer of claim 1, wherein the multi-functional (meth)acrylate polymer has a glass transition temperature in a range of from 20 to 90° C.

7. The multi-functional (meth)acrylate polymer of claim 1, wherein the multi-functional (meth)acrylate polymer has a weight-average molecular weight in a range of from 4000 g/mol to 40000 g/mol.

8. The multi-functional (meth)acrylate polymer of claim 1, wherein the multi-functional (meth)acrylate polymer has a polydispersity index, M_{w}/Mₙ, in a range of from 1 to 5.

9. The multi-functional (meth)acrylate polymer of claim 1, wherein the multi-functional (meth)acrylate polymer has an iodine number in a range of from 5 to 100 g of iodine per 100 g of polymer.

10. The multi-functional (meth)acrylate polymer of claim 1, wherein the multi-functional (meth)acrylate polymer has a hydroxyl number in a range of from 3 to 300 mg KOH/g.

11. A coating composition, comprising: 40% to 80% by weight of at least one polymer of claim 1.

12. The coating composition of claim 11, wherein the solids content is at least 50% by weight.

13. The coating composition of claim 11, wherein the coating composition comprises at least one crosslinking agent.

14. The coating composition of claim 13, wherein the crosslinking agent comprises or releases a polyisocyanate.

15. The coating composition of claim 13, wherein the coating composition comprises 0.5% to 10% by weight of a crosslinking agent.

16. A method of producing a coating, the method comprising:
applying the coating composition of claim 14 to a substrate; and
curing the coating composition.

17. The method of claim 16, wherein the substrate comprises a metal.

18. A coated article obtained by the method of claim 16.

19. The multi-functional (meth)acrylate polymer of claim 1, wherein the multi-functional (meth)acrylate polymer has a unit derived from at least one selected from the group consisting of 2-hydroxyethyl (meth)acrylate, 2 hydroxypropyl (meth)acrylate and 3-hydroxypropyl (meth)acrylate.
